(19) United States
(12) Patent Application Publication
(10) Pub. No.: US 2024/0142702 A1
(43) Pub. Date: May 2, 2024

(54) OPTICAL FIBER CUTTING DEVICE

(71) Applicant: SUMITOMO ELECTRIC OPTIFRONTIER CO., LTD., Kanagawa (JP)

(72) Inventor: Shinsuke KURINO, Yokohama-shi, Kanagawa (JP)

(21) Appl. No.: 18/547,955

(22) PCT Filed: Feb. 25, 2022
(86) PCT No.: PCT/JP2022/007898

§ 371 Date: Aug. 25, 2023

(30) Foreign Application Priority Data
Feb. 26, 2021 (JP) 2021-030264

(51) Int. Cl. G02B 6/25; G02B 6/36

(52) U.S. Cl. CPC G02B 6/25; G02B 6/3616

(57) ABSTRACT

An optical fiber cutting device comprising: a main body having a positioning portion configured to position the optical fiber and a first magnet; and a moving part having a blade portion configured to put a scratch on the optical fiber and a second magnet, and attached to the main body to be movable between a first position and a second position, wherein the blade portion is capable of putting a scratch on the optical fiber while the moving part is moved from the first position to the second position, and wherein when the moving part is located at the second position, the second magnet is located at a position at which the respective same polarity sides of the second magnet and the first magnet face each other and which is closer to the first position than the first magnet.

### TECHNICAL FIELD

The present disclosure relates to an optical fiber cutting device.

This application claims priority and the benefit of Japanese Patent Application No. 2021-030264 filed on Feb. 26, 2021, the entire contents of which are incorporated herein by reference.

### BACKGROUND ART

Patent Literatures 1 and 2 disclose an optical fiber cutting device that automatically moves a slider having a blade portion after positioning an optical fiber using a magnetic force. Specifically, Patent Literature 1 discloses an optical fiber cutting device including a first magnet provided on a side surface of a slider (a surface parallel to a direction in which the slider is moved), and a second magnet and a third magnet provided on a main body. In Patent Literature 1, when the first magnet is moved to a position of the second magnet by manually moving the slider, the slider is moved in a direction of the third magnet by the repulsive force between the first magnet and the second magnet, and the slider is stopped at an initial position by the attractive force between the first magnet and the third magnet. In addition, Patent Literature 1 discloses that a magnetic force of the first magnet is made stronger than that of the second magnet in order to increase a force for moving the slider to the initial position.

Patent Literature 2 discloses an optical fiber cutting device including a first magnet and a third magnet provided on a main body, and a second magnet and a fourth magnet provided on a slider. In Patent Literature 2, after manually moving the slider to oppose the first magnet and the second magnet in a plane perpendicular to a moving direction of the slider, the slider is returned to an initial position by the repulsive force between the first magnet and the second magnet, and the slider is stopped at the initial position by the attractive force between the third magnet and the fourth magnet.

### CITATION LIST

### Patent Literature

Patent Literature 1: U.S. Patent Application Publication No. 2015/0323740
Patent Literature 2: U.S. Pat. No. 10,261,258

### SUMMARY OF INVENTION

An optical fiber cutting device according to one embodiment of the present disclosure is an optical fiber cutting device for cutting an optical fiber, and includes:
a main body having a positioning portion configured to position the optical fiber and a first magnet; and
a moving part having a blade portion configured to put a scratch on the optical fiber and a second magnet, and attached to the main body to be movable between a first position and a second position,
wherein the blade portion is capable of putting a scratch on the optical fiber while the moving part is moved from the first position to the second position, and
wherein when the moving part is located at the second position, the second magnet is located at a position at which the respective same polarity sides of the second magnet and the first magnet face each other and which is closer to the first position than the first magnet.

### BRIEF DESCRIPTION OF DRAWINGS

FIG. 1 is a perspective view showing a state in which a cover body of an optical fiber cutting device according to an embodiment of the present disclosure is opened.

FIG. 2 is a perspective view showing a state after the cover body of the optical fiber cutting device shown in FIG. 1 is closed and an optical fiber is cut.

FIG. 3 is a perspective view of a main body included in the optical fiber cutting device shown in FIG. 1.

FIG. 4A is a side view for showing how to use the optical fiber cutting device shown in FIG. 1, showing a state in which the cover body is opened and a moving part of the optical fiber cutting device is located at a first position.

FIG. 4B is a side view for showing how to use the optical fiber cutting device shown in FIG. 1, showing a state in which the cover body is closed from the state shown in FIG. 4A and the moving part is located at the first position.

FIG. 4C is a side view for showing how to use the optical fiber cutting device shown in FIG. 1, showing a state in which the moving part is moved from the state shown in FIG. 4B to a second position.

FIG. 4D is a side view for showing how to use the optical fiber cutting device shown in FIG. 1, showing a state in which the cover body is opened from the state shown in FIG. 4C.

FIG. 5 is a view showing a positional relationship among a first magnet, a second magnet, and a metal member in the state shown in FIG. 4A.

FIG. 6 is a view showing the positional relationship among the first magnet, the second magnet, and the metal member in the state shown in FIG. 4B.

FIG. 7 is a view showing the positional relationship among the first magnet, the second magnet, and the metal member in the state shown in FIG. 4C.

FIG. 8 is a view showing the positional relationship among the first magnet, the second magnet, and the metal member in the state shown in FIG. 4D.

FIG. 9A is a schematic view showing the positional relationship among the first magnet, the second magnet, and the metal member when the moving part is located at the first position.

FIG. 9B is a schematic view showing the positional relationship among the first magnet, the second magnet, and the metal member when the moving part is located at the second position.

### DESCRIPTION OF EMBODIMENTS

### Technical Problem

In order to improve the workability at the time of cutting an optical fiber, it is desirable to automatically return a slider to the vicinity of an initial position after cutting the optical fiber. In the optical fiber cutting device disclosed in Patent Literature 1, although a magnetic force relationship between the first magnet and the second magnet is considered, a positional relationship between the first magnet and the second magnet is not sufficiently studied, for example, and there is room for improvement with respect to smoothly returning the slider to the initial position. In addition, the optical fiber cutting device disclosed in Patent Literature 2 uses, for example, four magnets for moving the slider, so there is room to pursue a simpler configuration.

The present disclosure is an optical fiber cutting device capable of automatically returning a moving part having a blade portion to the vicinity of an initial position after cutting an optical fiber, and an object thereof is to provide an optical fiber cutting device capable of moving the moving part to the initial position with a simple configuration.

### Description of Embodiments of Present Disclosure

An optical fiber cutting device according to one embodiment of the present disclosure is an optical fiber cutting device for cutting an optical fiber, and includes:
a main body having a positioning portion configured to position the optical fiber and a first magnet; and
a moving part having a blade portion configured to put a scratch on the optical fiber and a second magnet, and attached to the main body to be movable between a first position and a second position,
wherein the blade portion is capable of putting a scratch on the optical fiber while the moving part is moved from the first position to the second position, and
wherein when the moving part is located at the second position, the second magnet is located at a position at which the respective same polarity sides of the second magnet and the first magnet face each other and which is closer to the first position than the first magnet.

According to this configuration, a force to move the moving part in a direction of the first position by the repulsive force between the first magnet and the second magnet is generated. Therefore, with a simple configuration, it is possible to automatically return the moving part having the blade portion to the vicinity of an initial position after cutting an optical fiber.

When the moving part is located at the second position, if the second magnet and the first magnet are located at the same position in a moving direction of the moving part, or the first magnet is closer to the first position than the second magnet, the moving part does not move toward the first position or is difficult to move, and therefore, for example, the moving part should be slightly moved toward the first position manually. In the present disclosure, when the moving part is located at the second position, the second magnet is configured to be closer to the first position than the first magnet, so it is possible to move the moving part to the initial position without causing such a problem.

In the optical fiber cutting device, preferably,
the main body further has a magnetic metal, and
when the moving part is located at the first position, the magnetic metal is located at a position facing the second magnet, and an attractive force between the second magnet and the magnetic metal causes the moving part to stop at the first position.

According to the above configuration, after moving the moving part in a direction of the first position by the repulsive force between the first magnet and the second magnet, the moving part can be stopped at the first position.

In addition, for example, if a magnet is used instead of the magnetic metal, the attractive force between the magnet and the second magnet may become stronger, increasing the force required to manually move the moving part from the first position to the second position. As a result, there is a concern that the workability may deteriorate or the moving part may be moved vigorously by applying an excessively high force, causing unintended damage to the optical fiber. In the above configuration, the above concern can be reduced by using the magnetic metal instead of the magnet.

### Effects of Present Disclosure

According to the configuration disclosed above, with a simple configuration, it is possible to automatically return the moving part having the blade portion to the vicinity of the initial position after cutting the optical fiber.

### Details of Embodiments of Present Disclosure

Hereinafter, an example of an embodiment of the present disclosure will be described with reference to the drawings. In addition, in the following description, the same or equivalent elements are denoted with the same reference numerals even in the different drawings, and the overlapping descriptions thereof are appropriately omitted. Further, in each drawing used in the following description, the scale is changed as necessary to make each member recognizable.

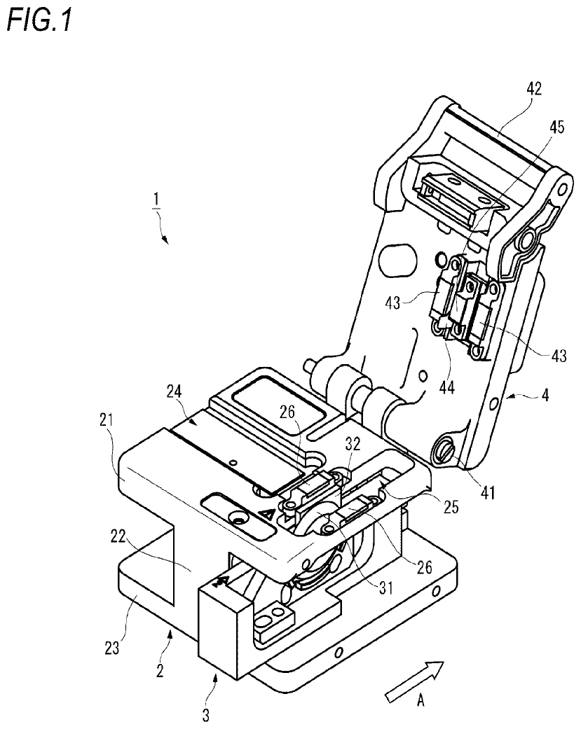

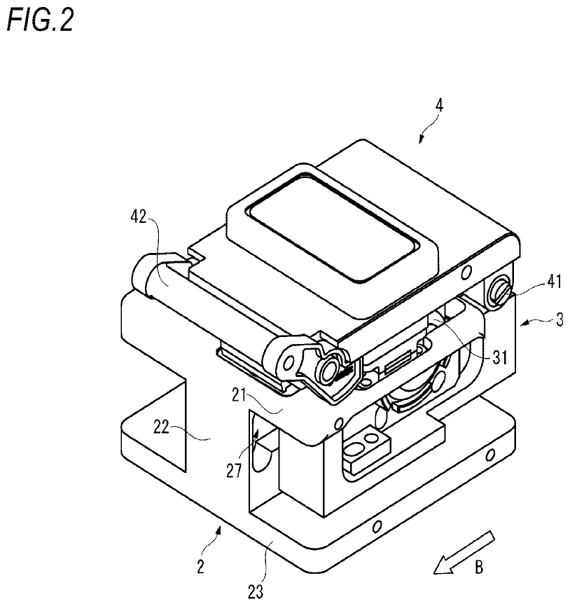

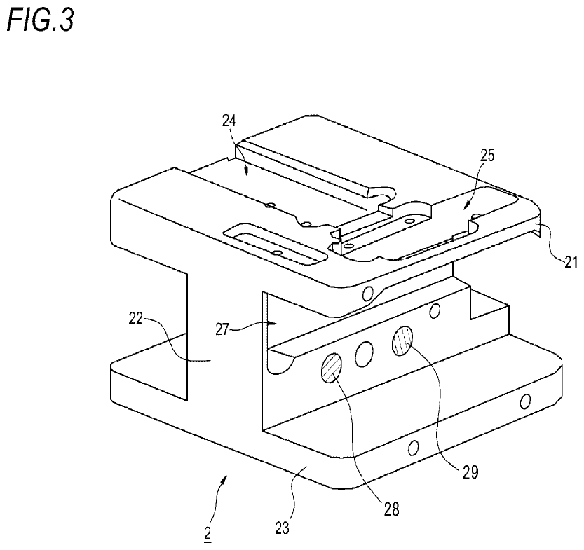

First, a configuration of an optical fiber cutting device according to the present embodiment will be described with reference to FIGS. 1 to 3. FIG. 1 is a perspective view showing a state in which a cover body 4 of an optical fiber cutting device 1 according to the present embodiment is opened. FIG. 2 is a perspective view showing a state after the cover body 4 of the optical fiber cutting device 1 shown in FIG. 1 is closed and an optical fiber is cut. FIG. 3 is a perspective view of a main body 2 included in the optical fiber cutting device 1 shown in FIG. 1. Note that, in the present specification, a front side in a direction of an arrow A shown in FIG. 1 is referred to as “front” and a rear side is referred to as “rear”, and similarly, a front side in a direction of an arrow B shown in FIG. 2 is referred to as “rear” and a rear side is referred to as “front”. This is for convenience of description and does not limit the present disclosure.

The optical fiber cutting device 1 is a device for cutting an optical fiber (not shown). The optical fiber cutting device 1 includes a main body 2, a moving part 3, a cover body 4, and a support shaft 41.

The main body 2 has a top plate portion 21, a bottom plate portion 23 arranged below the top plate portion 21, and a connecting portion 22 connecting the top plate portion 21 and the bottom plate portion 23. The main body 2 is formed to have a substantially I-shaped cross-section by the top plate portion 21, the connecting part 22, and the bottom plate portion 23. The main body 2 is made of, for example, metal or resin that is not ferromagnetic.

The top plate portion 21 has a positioning portion 24, an exposure hole 25, and a pair of lower clamp portions 26. The positioning portion 24 is provided on an upper surface of the top plate portion 21. The positioning portion 24 positions an optical fiber to be cut. The optical fiber is fixed by, for example, an optical fiber holder (not shown), and is cut while the optical fiber holder is positioned by the positioning portion 24. The exposure hole 25 is provided near the positioning portion 24 so as to extend in a direction orthogonal to an axis direction of the optical fiber positioned by the positioning portion 24. The pair of lower clamp portions 26 are fixed to sandwich the exposure hole 25 therebetween.

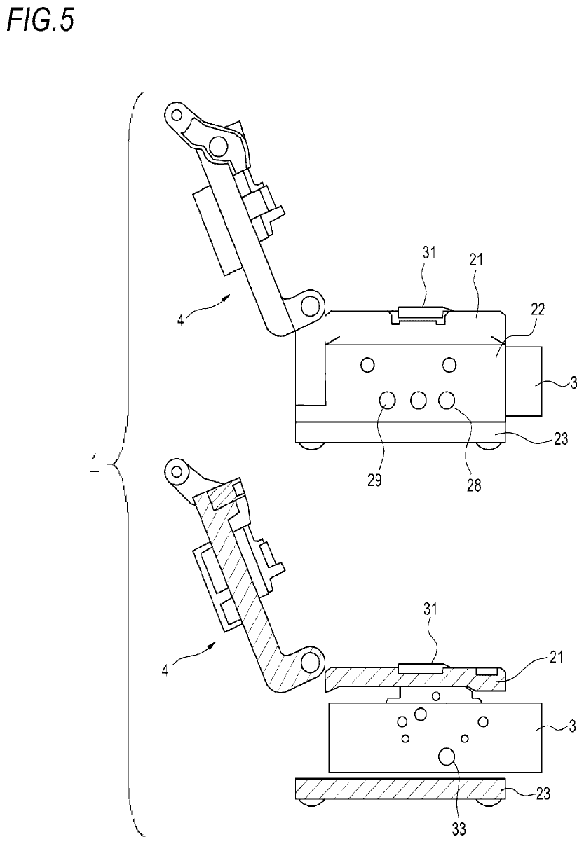

The connecting portion 22 includes a guide portion 27, a metal member 28, and a first magnet 29. The guide portion 27 is provided to extend along a moving direction of the moving part 3 (for example, the front-rear direction). The guide portion 27 is, for example, a substantially U-shaped groove in cross section, and guides movement of the moving part 3. The metal member 28 is a magnetic metal, and has a property of attracting a second magnet 33 (refer to FIGS. 5 to 9B) described below. The metal member 28 is formed of, for example, a ferromagnetic material such as iron, nickel, cobalt, and an alloy thereof. Note that the metal member 28 is preferably a metal rather than a magnet, as described above, but may be a magnet as long as it is arranged to attract the second magnet 33. The first magnet 29 is arranged to generate a repulsive force between the first magnet and the second magnet 33 when it is located at a position facing the second magnet 33. The operations of the metal member 28, the first magnet 29 and the second magnet 33 will be described in detail with reference to FIGS. 5 to 9B in the following paragraphs.

Between the top plate portion 21 and the bottom plate portion 23, the moving part 3 is attached to the main body 2 to be movable between a first position (position shown in FIG. 1) and a second position (position shown in FIG. 2). The moving unit 3 may be configured to move linearly between the first position and the second position, may be configured to move along a locus including a curve, or may be configured to be able to move in both the manners. When enabling the movement in both the manners, a moving aspect of the moving unit 3 is configured to be selectable in use, for example.

For example, a guide block (not shown) having a ball slide (not shown) is provided on a side surface of the moving part 3 on the connecting part 22 side. The guide block is slidably supported via the ball slide by the guide portion 27, and enables the moving part 3 to move in the front-rear direction. In the present embodiment, the moving part 3 is configured to be movable only toward the rear side (A direction) from the first position and to be movable only toward the front side (B direction) from the second position.

The moving part 3 has a blade portion 31, a protruding portion 32, and a second magnet 33. The blade portion 31 is moved along with the movement of the moving part 3, and is arranged to put a scratch on the optical fiber while the moving part 3 is moved from the first position to the second position. A shape of the blade portion 31 is not particularly limited, but is a round blade in the present embodiment. The blade portion 31 may be configured to move linearly, may be configured to move along a locus forming a gentle circular arc, when seen from a side, or may be configured to be able to move in both the manners, along with the movement of the moving part 3.

The protruding portion 32 press-fits an engaging piece 44 of the cover body 4 while moving the moving part 3 from the first position to the second position in a state where the cover body 4 is closed. The engaging piece 44 is, for example, a projection formed of a flexible member, and can be elastically deformed. In a state where the engaging piece 44 is press-fitted, a breaking member 45 is maintained in a state of resisting an urging force of a spring (not shown). In addition, when the moving part 3 is further moved and reaches the second position, the protruding portion 32 passes through the engaging piece 44, and the breaking member 45 gets out of the state of resisting the urging force of the spring. Then, the breaking member 45 is lowered by the urging force and collides with a glass fiber portion of the optical fiber, and the optical fiber is cut starting from the scratch made on the glass fiber portion by the blade portion 31 while the moving part 3 is moved from the first position to the second position.

In addition, in a state where the protruding portion 32 passes through the engaging piece 44 and the moving part 3 reaches the second position, the engaging piece 44 is engaged with the protruding portion 32 to regulate movement of the moving part 3 in the B direction. Further, when the cover body 4 is opened, the engagement between the protruding portion 32 and the engaging piece 44 is released, and the moving part 3 can be moved to the first position. The second magnet 33 will be described in detail with reference to FIGS. 5 to 9B in paragraphs below.

The cover body 4 is connected to the main body 2 via the support shaft 41 to be openable/closable. The cover body 4 has a handle 42, a pair of upper clamp portions 43, the engaging piece 44, and the breaking member 45. The handle 42 is a knob for a user to grip when opening/closing the cover body 4. The pair of upper clamp portions 43 are arranged to face the pair of lower clamp portions 26, respectively. In the state in which the cover body 4 is closed, the glass fiber portion of the optical fiber to be cut is sandwiched and fixed between the upper clamp portions 43 and the lower clamp portions 26. The engaging piece 44 is as already described. The breaking member 45 is provided between the pair of upper clamp portions 43. The breaking member 45 presses the glass fiber portion of the optical fiber scratched by the blade portion 31, thereby developing the scratch to break and cut the glass fiber portion.

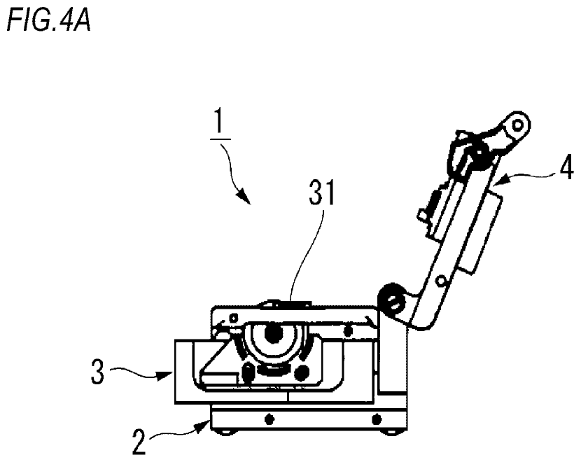

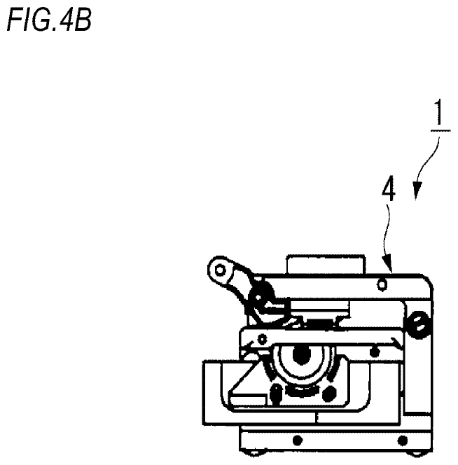

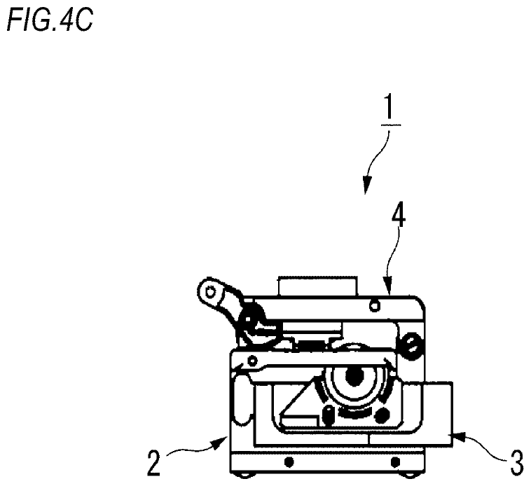

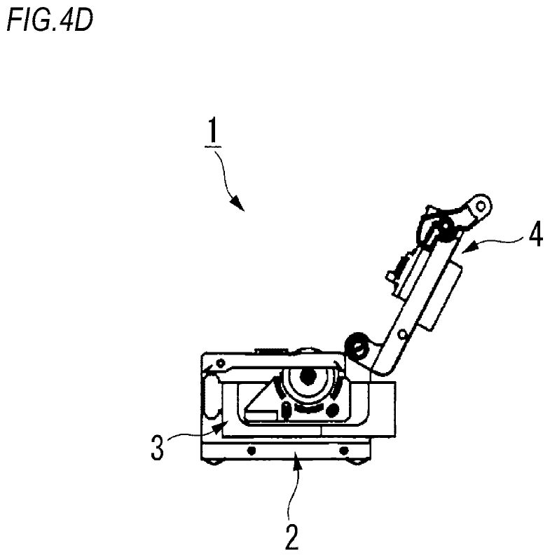

Next, a method of using the optical fiber cutting device 1 will be described with reference to FIGS. 4A to 4D. FIGS. 4A to 4D are side views showing how to use the optical fiber cutting device 1. FIG. 4A shows a state in which the cover body 4 is opened and the moving part 3 is located at the first position. In this state, the user positions the optical fiber to be cut. FIG. 4B shows a state in which the cover body 4 is closed from the state in FIG. 4A, and the moving part 3 is located at the first position. In this state, the glass fiber portion of the optical fiber is sandwiched and fixed between the upper clamp portions 43 and the lower clamp portions 26.

FIG. 4C is a state in which the moving part 3 is moved to the second position from the state shown in FIG. 4B. While the moving part 3 is moved from the first position to the second position, the glass fiber portion of the optical fiber is scratched by the blade portion 31 and then pressed by the breaking member 45, so that the scratch is developed and the optical fiber is resultantly cut. In addition, in the state of FIG. 4C, the movement of the moving part 3 in the B direction is regulated by the protruding portion 32 and the engaging piece 44. FIG. 4D shows a state in which the cover body 4 is opened from the state shown in FIG. 4C. In FIG. 4D, since the engagement between the protruding portion 32 and the engaging piece 44 is released, the moving part 3 can be moved in the B direction. Then, by the operations of the metal member 28, the first magnet 29 and the second magnet 33, the moving part 3 is automatically moved to the first position, i.e., returns to the state shown in FIG. 4A.

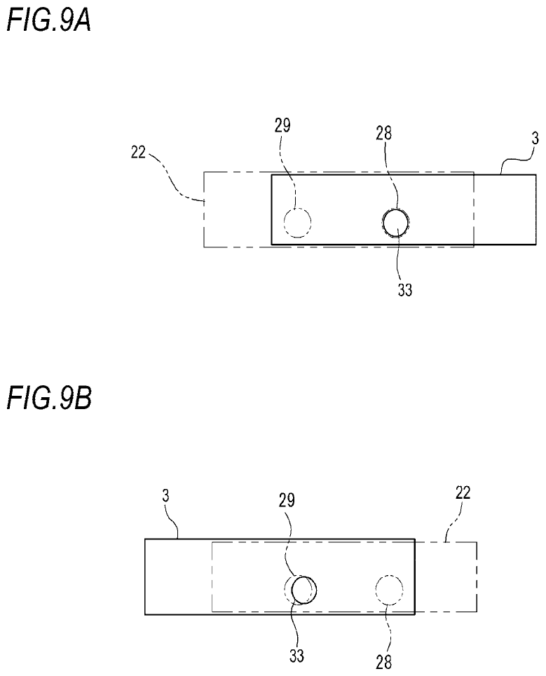

Next, the operations of the metal member 28, the first magnet 29 and the second magnet 33 will be described in detail with reference to FIGS. 5 to 9B. FIGS. 5 to 8 are views showing positional relationships among the metal member 28, the first magnet 29, and the second magnet 33 in the states of FIGS. 4A to 4D, respectively. Note that FIGS. 5 to 8 are views when FIGS. 4A to 4D are seen from opposite sides. FIG. 9A is a schematic view showing the positional relationship among the first magnet, the second magnet, and the metal member 28 when the moving part 3 is located at the first position. FIG. 9B is a schematic view showing the positional relationship among the first magnet, the second magnet, and the metal member 28 when the moving part 3 is located at the second position.

As shown in FIG. 5, in the state of FIG. 4A, the metal member 28 and the second magnet 33 are located at corresponding positions. Specifically, as shown in FIG. 9A, the metal member 28 and the second magnet 33 are located at positions facing each other. In this state, an attractive force is generated between the second magnet 33 and the metal member 28 by a magnetic force generated from the second magnet 33. As a result, the moving part 3 is maintained at the first position.

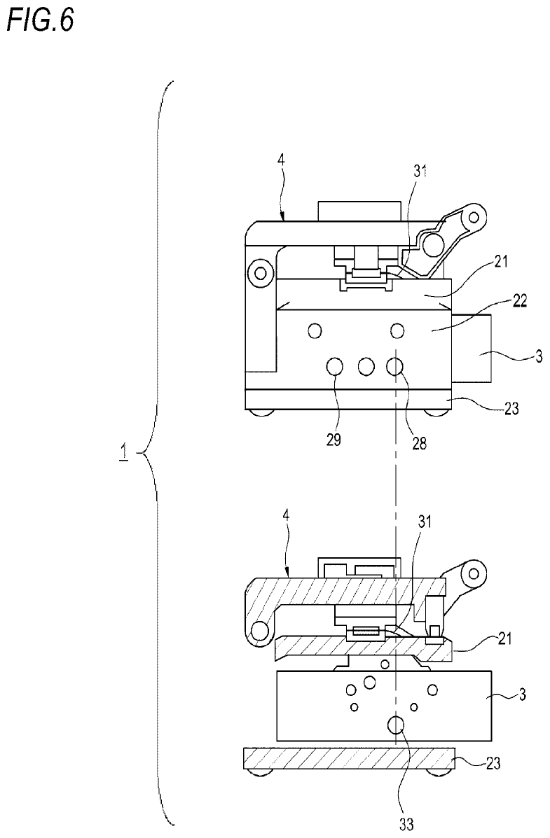

As shown in FIG. 6, even in the state of FIG. 4B, the positional relationship among the metal member 28, the first magnet 29, and the second magnet 33 does not change, and the moving part 3 is maintained at the first position. From this state, when the user applies a force to move the moving part 3 in the A direction, the moving part 3 is moved in the A direction at a stage where the applied force exceeds the attractive force generated between the second magnet 33 and the metal member 28.

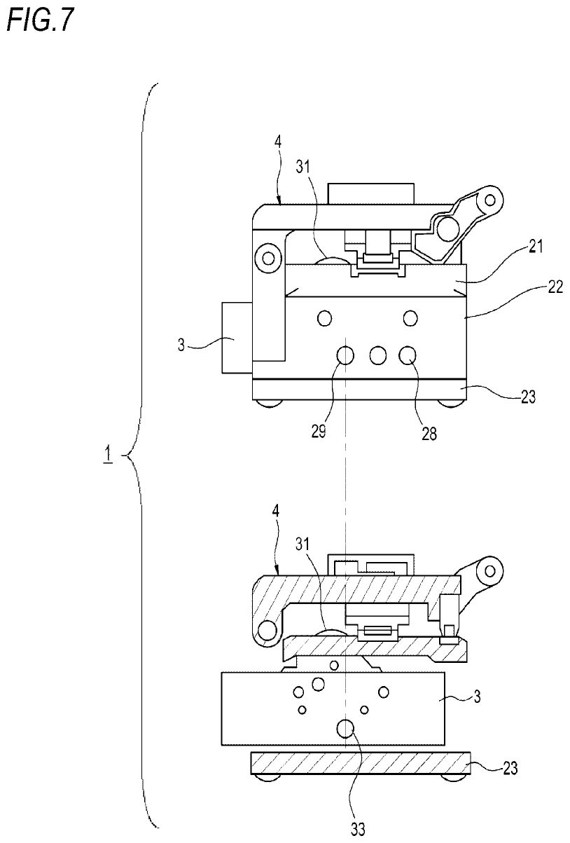

As shown in FIG. 7, in the state of FIG. 4C, i.e., in the state in which the moving part 3 is located at the second position, the first magnet 29 and the second magnet 33 are located at corresponding positions. Specifically, as shown in FIG. 9B, the first magnet 29 and the second magnet 33 are located at positions facing each other. In this state, the first magnet 29 and the second magnet 33 are arranged so that the respective same polarity sides face each other, in order to generate a repulsive force between the first magnet 29 and the second magnet 33.

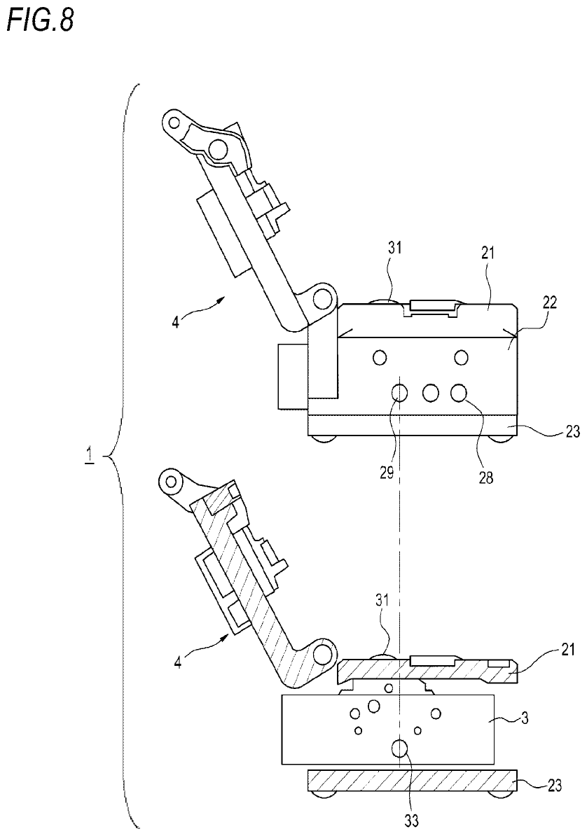

Further, in this state, the second magnet 33 is arranged to be located at a position closer to the first position than the first magnet 29, i.e., on the front side. With this arrangement, in the state of FIG. 4C, the repulsive force acting on the front side is stronger on the rear side. Then, when the state of FIG. 4D shown in FIG. 8 is reached, the moving part 3 is automatically moved in the B direction (from the rear toward the front) by the repulsive force described above. Then, the moving part 3 is stopped at a position where the metal member 28 and the second magnet 33 face each other.

Sizes of the opposing surfaces, which are surfaces on which the first magnet 29 and the second magnet 33 face each other, may be the same or different. The facing surface of the first magnet 29 is preferably larger than the facing surface of the second magnet 33, from a standpoint of making it easier for the first magnet 29 and the second magnet 33 to be located at positions facing each other at the second position, regardless of which movement locus is selected by the user when there are two or more movement loci of the moving part 3.

In addition, in the embodiment described above, the main body 2 has the metal member 28 and the first magnet 29, and the moving part 3 has the second magnet 33. However, the main body 2 may have the second magnet 33, and the moving part 3 may have the metal member 28 and the first magnet 29.

Although the present disclosure has been described in detail with reference to the specific embodiments, it is obvious to one skilled in the art that a variety of changes and modifications can be made without departing from the spirit and scope of the present disclosure. In addition, the numbers, positions, shapes, and the like of the constitutional members described above are not limited to those in the above embodiment, and can be changed to suitable numbers, positions, shapes, and the like when implementing the present disclosure.

### REFERENCE SIGNS LIST

1: optical fiber cutting device
2: main body
21: top plate portion
22: connecting portion
23: bottom plate portion
24: positioning portion
25: exposure hole
26: lower clamp portion
27: guide portion
28: metal member (magnetic metal)
29: first magnet
3: moving part
31: blade portion
32: protruding portion
33: second magnet
4: cover body
41: support shaft
42: handle
43: upper clamp portion
44: engaging piece
45: breaking member

What is claimed is:

1. An optical fiber cutting device for cutting an optical fiber, the optical fiber cutting device comprising:
a main body having a positioning portion configured to position the optical fiber and a first magnet; and
a moving part having a blade portion configured to put a scratch on the optical fiber and a second magnet, and attached to the main body to be movable between a first position and a second position,
wherein the blade portion is capable of putting a scratch on the optical fiber while the moving part is moved from the first position to the second position, and
wherein when the moving part is located at the second position, the second magnet is located at a position at which the respective same polarity sides of the second magnet and the first magnet face each other and which is closer to the first position than the first magnet.

2. The optical fiber cutting device according to claim 1, wherein the main body further has a magnetic metal, and
wherein when the moving part is located at the first position, the magnetic metal is located at a position facing the second magnet, and an attractive force between the second magnet and the magnetic metal causes the moving part to stop at the first position.

3. The optical fiber cutting device according to claim 1, wherein the main body includes a top plate portion, and the positioning portion is provided on an upper surface of the top plate portion.

4. The optical fiber cutting device according to claim 3, wherein the positioning portion includes a recess provided on the upper surface of the top plate portion.
